(19) United States
(12) Patent Application Publication
(10) Pub. No.: US 2010/0053539 A1
(43) Pub. Date: Mar. 4, 2010

(54) LIQUID CRYSTAL LENS WITH VARIABLE FOCUS

(76) Inventor: Jau-Jeng LIN, Taipei (TW)

Correspondence Address: Muncy, Geissler, Olds & Lowe, PLLC, P.O. BOX 1364, FAIRFAX, VA, 22038-1364, US

(21) Appl. No.: 12/409,066

(22) Filed: Mar. 23, 2009

(30) Foreign Application Priority Data
Sep. 4, 2008 (TW) 097133932

(51) Int. Cl. G02F 1/13

(52) U.S. Cl. 349/200

(57) ABSTRACT

A liquid crystal lens with variable focus formed by a single layer or multiple layers of liquid crystal lens unit is revealed. The liquid crystal lens unit includes two glass substrates with preset thickness and arranged in parallel so as to form a middle space for accommodation of liquid crystal layer. By etching, an aluminum membrane, silver membrane or other transparent metal membranes to form surface electrode patterns that can be controlled independently. The arrangement and the refractive index of each liquid crystal layer can be tuned by adjustment of the applied voltage so as to improve image quality, increase focus switch speed, improve easiness of assembling, reduce whole thickness of the lens, and the manufacturing cost.

### BACKGROUND OF THE INVENTION

The present invention relates to a liquid crystal lens with variable focus, especially to a glass substrate with surface electrode pattern formed by transparent metal membrane for independently tuning optical properties of each liquid crystal lens unit. The liquid crystal lens is applied to cameras, phone cameras or 3D image processing devices and so on.

Generally cameras, phone cameras or 3D image processing devices are disposed with varifocal lenses for magnifying or minimizing images. A conventional lens includes a plurality of lens groups. By movement of the lens groups along an optical axis, the distance between the lens group is changed so as to change the focal length. Such kind of lens requires longer distance for movement of the lens groups and the distance is nonlinear relationship. Thus such structure has difficulties in design, control precision and the manufacturing cost is also quite high. There are some other devices that use liquid lenses or liquid crystal lens (LC lens) to improve such condition-the movement distance of the lens groups for minimizing camera size. The liquid lens includes a tunable liquid filled lens and a solid lens. By changing shape (biconvex or concave-convex) of the lens or using different fillers with various refractive indexes, the focal length of the lens is adjusted and variable focal length is available, as prior arts revealed in Susumu Sato; “Liquid-Crystal Lens-Cells with Variable Focal Length”, Japanese Journal of Applied physics, published on Mar. 12, 1979 and US2007/0217023. The variable focal length of the liquid crystal lens with is achieved by applying non-uniform or uniform electric filed on non-uniform or uniform liquid crystal layers and then the refractive index is gradually changed so as to adjust focal length of the lens, as the device disclosed on Yun-Hsing Fan etc.; “Liquid crystal microlens arrays with switchable positive and negative focal lengths”, Journal of Display Technology, published on November 2005.

Due to excellent photoelectric properties and low operation voltage, liquid crystals are broadly used to make electrical control optical modulators. As shown in FIG. 1A, a conventional liquid crystal lens is formed by liquid crystal molecules 103 packed between two electrodes 102. Along with change of the voltage between the two electrodes 102, arrangement of the liquid crystal molecules is changed and further the optical path of the aperture of the liquid crystal lens is changed so as to get various focuses. Most of the electrodes of the liquid crystal lens is ITO electrode 101, formed by coating a layer of transparent conductive ITO (Indium Tin Oxide/Tin-doped Indium Oxide) membrane on a glass substrate. ITO has excellent conductivity, high visible light transmittance, and high infrared reflection. The resistance coefficient of ITO is lower than 2×10⁻⁴ Ω·cm and that's one hundred times than the coefficient of the best electrical conductor-silver. The liquid crystal layer is covered by two ITO membranes or one ITO membrane with one metal membrane and then is applied with a non-uniform electric field. Thus the thickness of the liquid-crystal layer fluctuates so that the refractive index of the liquid crystal lens changes form unfocused to focused or the focal length changes, as shown in U.S. Pat. No. 6,882,390, U.S. Pat. No. 7,388,822, US2007/0183293, TW M327490, JP08-258624, WO/1993/009524 and so on. However, the transparent conductive ITO membrane requires higher voltage so that ITO membrane has shortcomings of long response time and slow switching speed while being applied to the liquid crystal lens module. Therefore, such module is not suitable for cameras or phone cameras.

There is a further conventional technique that coats an aluminum membrane on a glass substrate and a specific aperture formed by etching of the aluminum membrane works as an electrode, instead of conventional electrodes formed by ITO, as shown in FIG. 1B, and the technique disclosed in US Pat. App. No. 2007/0183293. Refer to US Pat. App. No. 2007/0182915, the low-resistance metal-aluminum, gold, silver or chromium is used in combination with high resistance material-zinc oxide, lead oxide, or indium oxide. Refer to US Pat. App. No. 2007/0024801, the gold film is used as thermally conductive material. By applying the voltage, the arrangement of liquid crystal in the aperture is changed so as to change the focus. Due to various disposition of electrodes, the electric fields over and under the liquid crystal layer are different. Thus the refractive index is gradually changed. However, there is an edge attenuation that leads to poor image quality. Moreover, there are still some other problems such as high operation voltage, low focusing efficiency, dependence between the focusing efficiency and polarization, and narrow variable focus range. Thus there are quite a lot restrictions on the use. In order to solve above problems, some other conventional lenses are used in combination with the liquid crystal lens to form a compound lens so as to improve switching speed and image quality. But the whole thickness and the cost of the lens are also increase. And the switching speed of the focus is still a problem, not enhanced efficiency.

### SUMMARY OF THE INVENTION

Therefore it is a primary object of the preset invention to provide a liquid crystal lens with variable focus. A liquid crystal lens unit is formed by at least two glass substrates with preset thickness and having surface electrode pattern formed etching of a metal membrane on one side or both sides thereof. The glass substrates are arranged in parallel with preset distance to form a middle space for accommodation of liquid crystal molecules. A single-layer or multi-layer liquid crystal lens with variable focus is formed the liquid crystal lens unit. By applying the voltage, arrangement of the liquid crystal molecules in each liquid crystal lens unit is tuned independently so as to generate required optical properties. And the liquid crystal lens is applied to cameras, phone cameras or 3D image processing devices for change of the focus.

In order to achieve above object, a single-layer liquid crystal lens with variable focus of the present invention is formed by a single layer of the liquid crystal lens unit that includes two glass substrates with preset thickness being arranged in parallel with preset distance. An aluminum membrane, silver membrane or other transparent metal membranes is coated on the glass substrate by etching to form a surface electrode pattern on one side or both sides of the glass substrate, instead of conventional electrodes formed by ITO (Tin-doped Indium Oxide) transparent conductive membrane. The surface electrode patterns on both sides of the glass substrate can be the same symmetrical pattern or asymmetrical. Moreover, liquid crystal molecules are filled into a space between the two glass substrates to form a liquid crystal layer. When a specific voltage is applied to the surface electrode pattern, the liquid crystal molecules generate specific refractive index and optical properties. While being applied with different voltage, the liquid crystal molecules generate different refractive index as well as different optical properties so as to change focal length.

It is another object of the present invention to provide a liquid crystal lens with variable focus that consists of at least two layers of liquid crystal lens unit. The liquid crystal lens unit is formed by at least two glass substrates with preset thickness. In accordance with the same technique of the single-layer liquid crystal lens unit mentioned above, the liquid crystal lens can change focus.

It is a further object of the present invention to provide a liquid crystal lens with variable focus with a surface electrode pattern that is designed as a single hole pattern or a concentric circle pattern for providing changes of various optical properties such as aperture, refractive index and focal length.

It is a further object of the present invention to provide a liquid crystal lens with variable focus in which surface electrode patterns respectively on two sides of a liquid crystal layer are made of the same material and are easy to be adjusted to well-symmetrical status so as to reduce decentered problems of apertures of the liquid crystal lens. Moreover, in prior arts, surface electrode patterns made from at least one ITO membrane in combination of a metal membrane may have little difference due to different material. Thus while being applied with voltage, the anchoring force of the different surface electrode patterns acted on the liquid crystals are existing variations. This has effects on final polarization effects of the aperture of the liquid crystal lens.

According to requirements of optical design, single or multiple layers of the liquid crystal lens unit are used in combination with various surface electrode patterns. Moreover, by independent control of voltage of the liquid crystal lens unit, optical properties such as refractive index and aperture size are changed so as to improve switch speed of the focus and optimize optical effects as well as varifocal quality. Furthermore, the thickness of the whole lens and manufacturing cost are reduced.

### BRIEF DESCRIPTION OF THE DRAWINGS

FIG. 1A, 1B are side views of a conventional liquid crystal lens;

FIG. 2 is a perspective view of a single-layer liquid crystal lens according to the present invention;

FIG. 3 is a schematic drawing showing the single-layer liquid crystal lens according to the present invention;

FIG. 4A shows an electric field acted on surface electrode patterns (asymmetrical upper and lower surface electrode patterns);

FIG. 4B shows the electric field in the FIG. 4A acted on liquid crystal molecules;

FIG. 5A shows an electric field acted on surface electrode patterns (symmetrical upper and lower surface electrode patterns);

FIG. 5B shows the electric field in the FIG. 5A acted on liquid crystal molecules;

FIG. 6 is a schematic drawing showing relationship between refractive index and incident angle;

FIG. 7A, FIG. 7B, & FIG. 7C respectively show a path of light of a single-layer liquid crystal lens unit of an embodiment according to the present invention being applied with different voltage;

FIG. 8 shows manufacturing processes of a double-side electrode glass substrate of an embodiment according to the present invention;

FIG. 9 is a side view with a light path of a double-layer liquid crystal lens unit of an embodiment according to the present invention;

FIG. 10 is a side view with a light path of a multiple-layer liquid crystal lens unit of an embodiment according to the present invention.

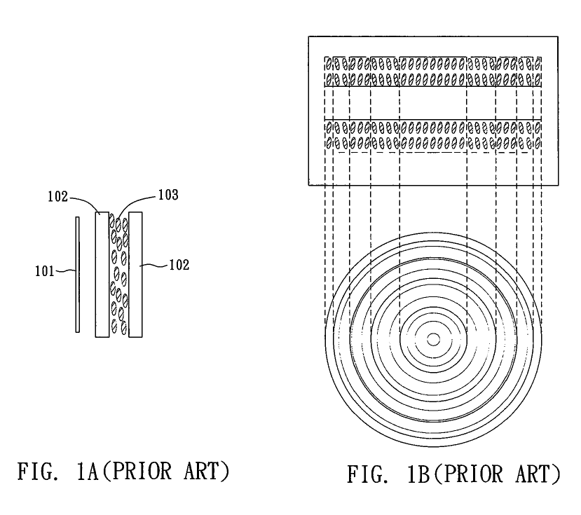

### DETAILED DESCRIPTION OF THE PREFERRED EMBODIMENT

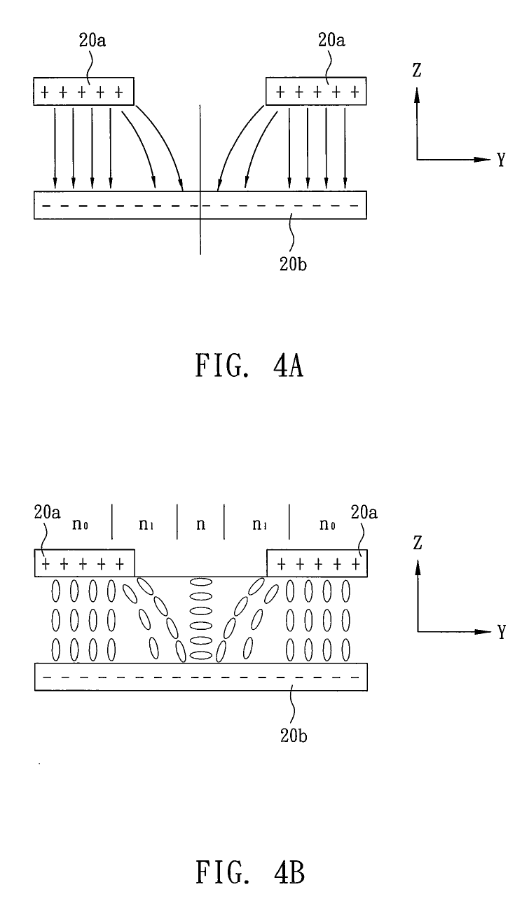

Refer to FIG. 4A, an upper surface electrode pattern 20a and a lower surface electrode pattern 20b respectively carry positive electric charge and negative electric charge so that electric field lines become bended. After a liquid crystal layer 30 being formed between the upper and the lower surface electrode patterns 20a, 20b, as shown in FIG. 4B, liquid crystal molecules of the liquid crystal layer 30 are influent by torque force which is generated by electric field. In order to achieve minimum energy stable, the axis of liquid crystals molecules of the liquid crystal layer 30 is tuned to parallel to the external electric field (tangent to the electric field), oriented in a specific way with specific refractive index and optical properties. Since the anisotropic of liquid crystal molecules in the liquid crystal layer 30, the liquid crystal molecules are bi-refraction, and, the light enters a bi-refraction material, the light polarization direction relates to the axis of the liquid crystal molecules, that the orthogonal vector of incident light field polarize the liquid crystal molecules. On edge of the electric field, area outside the electric field, the axis of liquid crystal molecules is forced and affected by the electric field so that the liquid crystal molecules in this area is with refractive index no; near a center between the two electric fields, area near the electric field, the electric field lines make the axis of the liquid crystal molecules of the liquid crystal layer 30 changed so as to have the refractive index n₁. On the center of the two electric fields, the axis of the liquid crystal molecules is not affected by the electric field and the refractive index here is n. Thus along Y direction, the refractive index changes: n₀-n₁-n-n₁-n₀ so as to from a refractive index gradient. When the upper and the lower surface electrode patterns 20a, 20b are applied with electric field with different strength, various refractive indexes are generated in Z direction so that the focus is changed while the light is passing.

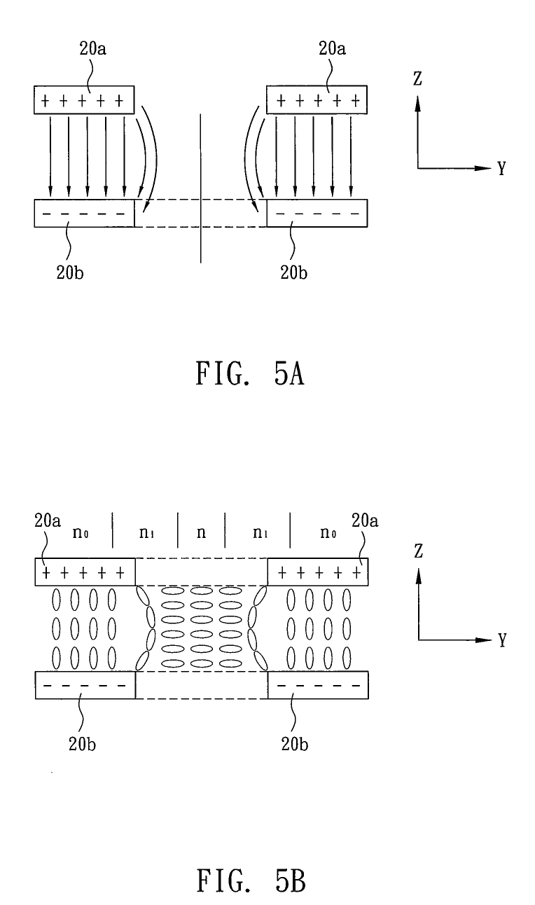

If the upper and the lower surface electrode patterns 20a, 20b are symmetrical, as shown in FIG. 5A, 5B, the area near the electric field is getting smaller so that the refractive index change is similar to n₀-n-n₀, a refractive index gradient different from that in FIG. 4B is formed.

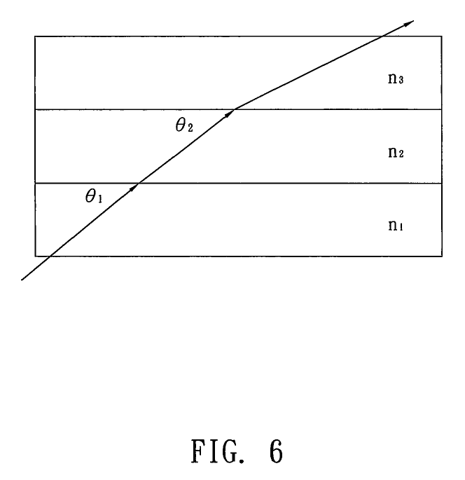

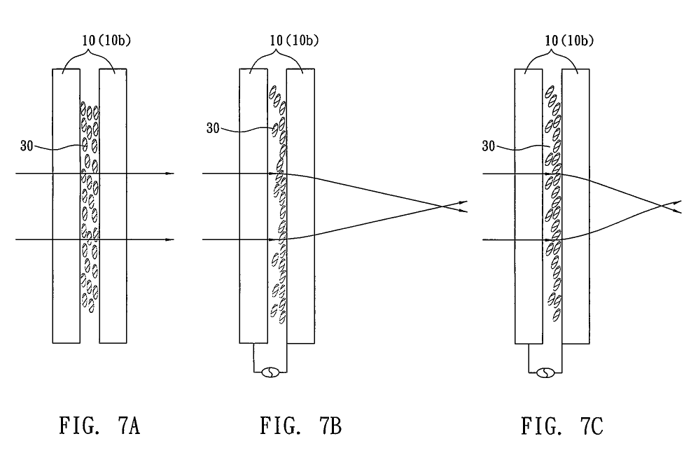

By different directions of the polarization of photoelectric field and the liquid crystal molecules, a liquid crystal lens unit 1 with different refractive indexes (refractive index gradient) similar to a GRIN (gradient index) lens is made. By application of different external electric field, the refractive index gradient is changed so that angle of the incident light inside the liquid crystal lens unit 1 changes to be focused, as shown in FIG. 6, FIG. 7A, FIG. 7B, & FIG. 7C. Refer to FIG. 6, the lens with different refractive index gradients is divided into a plurality of (number n) layers to be analyzed according to the following snell's law:

n₁ cos(θ₁)=n₂ cos(θ₂)=. . . nᵢ cos(θᵢ)=. . . =nₙ cos(θₙ) (1)

wherein nᵢ is assumed to be a refractive index of the i-th layer, 90° -θᵢ is an angle between the normal to the interface (between the i-th layer and the i+1-th layer) and the light of the i-th layer.

Various refractive indexes nᵢ are formed due to liquid crystals in the liquid crystal lens unit 1 affected by different magnitude of the electric field while nᵢ is difficult to be measured. The average refractive index n̅ and change rate of the refractive index α are alternative to estimate the focal length f by the following equation:

$$\frac{1}{f} = \overline{n} αsin ( α \cdot D ) \qquad ( 2 )$$

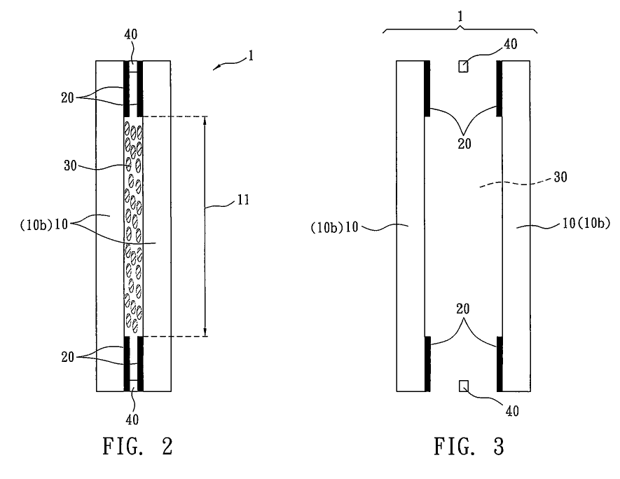

For the liquid crystal layer 30 with certain thickness D, the refractive index gradient will be changed (the average refractive index n̅ and the rate of the refractive index α changed) by the variation of the magnitude and direction of the electric field. Thus the different emergent angle and different focal length can be obtained, as shown in FIG. 7A, FIG. 7B, & FIG. 7C. As for liquid crystal lens units, the refractive index can be changed when voltage is applied to the surface electrode patterns 20 so that light is converged or diverged to form a lens set with variable focus. Moreover, the upper and a lower surface electrode patterns 20a, 20b are disposed symmetrically or asymmetrically. For further designs, the surface electrode patterns 20 can be designed as a single hole pattern, concentric circle pattern, or other patterns to have various aperture effects. Noted that, FIG. 2, 3, 8, 10 are illustrated as the symmetric and single-hole surface electrode pattern.

### The First Embodiment

Refer to FIG. 2 & FIG. 3, a single-layer liquid crystal lens with variable focus 1 of the present invention comprising: in the order from an object side to an image side, a single-side electrode glass substrate 10b (a glass substrate 10 disposed with a surface electrode pattern 20 on one side), a spacer 40, a liquid crystal layer 30 and a single-side electrode glass substrate 10b. Wherein, the surface electrode pattern 20 is a metal membrane such as aluminum, silver or gold membrane coated on the glass substrate 10 and the metal membrane is transparent, aluminum surface electrode pattern is used in this embodiment. Wherein, the surface electrode pattern 20 is a single hole pattern, the membrane is etched to form a single-hole aperture 11. Wherein, the spacer 40 can be a circular piece or overlapped circular pieces. The distance of a gap between the two glass substrates 10 is defined by the spacer 40 and this is also the thickness of the liquid crystal layer 30.

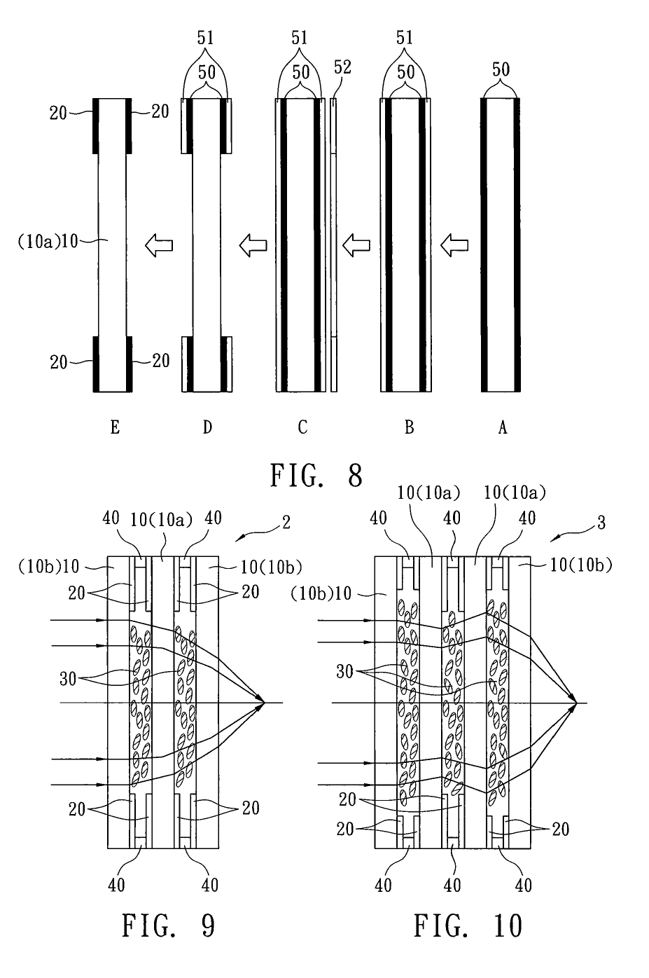

Refer to FIG. 8, it shows manufacturing processes of a double-side electrode glass substrate 10a (a glass substrate 10 disposed with a surface electrode pattern 20 on both sides respectively) and the manufacturing processes of the single-side electrode glass substrate 10b are also similar. Firstly, a metal membrane is coated on surface of the glass substrate 10 by vapor deposition (CVD or PVD) or sputtering deposition. Then the required pattern of the surface electrode pattern 20 is etched and formed by photolithography processes. The steps of the photolithography processes are as followings: arrange a photoresist layer 51 on the metal membrane 50. Then a photo mask 52 with specific pattern is covered on the light resistant layer 51. Through processes of exposure, development, washing and etching, the light resistant layer 51, the photoresist layer 51 and metal membrane outside area of the specific pattern of the surface electrode pattern 20 are all removed. Next the rest photoresist layer 51 is removed and the surface electrode pattern 20 is formed. Once the surface electrode patterns 20 on both sides of the double-side electrode glass substrate 10a are symmetrical to each other, the etching can be finished at the same time by a double-side photolithography machine. Once they are asymmetrical, different photo masks 52 and a single-side photolithography machine are used to produce the glass substrate 10a.

Generally, in order to control the operation voltage not over a certain range, the ratio of the size of the aperture 11 formed by the single hole surface electrode pattern 20 to the thickness of the liquid crystal layer 30 is 2.5/1. The size of the aperture 11 ranges from 100 μm to 1 mm. The liquid crystal material used in this embodiment is the nematic liquid crystal E7, the thickness of the glass substrates 10 on the object side and on the image side respectively is 1 mm, 0.5 mm, and the thickness D of the liquid crystal layer 30 is 120 μm.

Refer to List one and FIG. 11, the focal length of this embodiment changes by applying various voltage on the surface electrode pattern 20.

List One

| | focal length (mm) | Voltage (V) |
|---|---|---|
| 1 | 0.877 | 2.68 |
| 2 | 1.013 | 2.31 |
| 3 | 1.111 | 2.15 |
| 4 | 1.226 | 2.03 |
| 6 | 1.418 | 1.89 |
| 7 | 1.514 | 1.82 |
| 8 | 1.720 | 1.74 |
| 9 | 1.908 | 1.68 |
| 10 | 2.217 | 1.59 |
| 11 | 2.525 | 1.49 |

The list 2 to list 5 show related optical parameters of the embodiment with different focal length, focal number and back focal length (BL)(mm), and different angle (deg.)(angle of the incident light to the optical axis): spot size RMS (root-means-square, μm), spot size GEO (Geometric, μm), field TAN (Tangential field curvature), field SAG(Sagittal field curvature), distortion rate (%), 60°MTF(TAN)( Modulation Transfer Function at 60°TAN) and 60°MTF(SAG).

List Two

f = 1.013 Fno = 6.786 BL = 0.658

| angle | spotsize | spotsize | Field | Field | Dis- | MTF | MTF |
|---|---|---|---|---|---|---|---|
| (deg.) | RMS | GEO | TAN | SAG | tortion | (TAN) | (SAG) |
| 0 | 0.612 | 1.389 | 0.000 | 0.000 | 0.000 | 0.695 | 0.695 |
| 2.5 | 0.683 | 1.827 | −0.002 | −0.001 | −0.024 | 0.694 | 0.694 |
| 5 | 0.936 | 2.640 | −0.010 | −0.004 | −0.110 | 0.687 | 0.693 |
| 7.5 | 1.428 | 3.852 | −0.021 | −0.009 | −0.237 | 0.668 | 0.689 |
| 10 | 2.150 | 5.492 | −0.037 | −0.015 | −0.410 | 0.625 | 0.680 |
| 12.5 | 3.136 | 7.607 | −0.059 | −0.024 | −0.657 | 0.547 | 0.664 |
| 15 | 4.395 | 10.256 | −0.082 | −0.034 | −0.919 | 0.428 | 0.638 |

List Three

f = 1.111 Fno = 7.422 BL = 0.753

| angle | spotsize | spotsize | Field | Field | Dis- | MTF | MTF |
|---|---|---|---|---|---|---|---|
| (deg.) | RMS | GEO | TAN | SAG | tortion | (TAN) | (SAG) |
| 0.0 | 0.204 | 0.472 | 0.000 | 0.000 | 0.000 | 0.671 | 0.671 |
| 2.5 | 0.313 | 0.899 | −0.002 | −0.001 | −0.023 | 0.671 | 0.671 |
| 5.0 | 0.638 | 1.706 | −0.010 | −0.004 | −0.091 | 0.666 | 0.670 |
| 7.5 | 1.182 | 2.916 | −0.024 | −0.009 | −0.206 | 0.651 | 0.668 |
| 10.0 | 1.959 | 4.558 | −0.042 | −0.017 | −0.388 | 0.614 | 0.661 |
| 12.5 | 2.986 | 6.676 | −0.066 | −0.027 | −0.610 | 0.543 | 0.648 |
| 15.0 | 4.297 | 9.327 | −0.093 | −0.038 | −0.852 | 0.430 | 0.625 |

List Four

f = 1.72 Fno = 11.489 BL = 1.363

| angle | spotsize | spotsize | Field | Field | Dis- | MTF | MTF |
|---|---|---|---|---|---|---|---|
| (deg.) | RMS | GEO | TAN | SAG | tortion | (TAN) | (SAG) |
| 0.0 | 0.202 | 0.428 | 0.000 | 0.000 | 0.000 | 0.500 | 0.500 |
| 2.5 | 0.282 | 0.779 | −0.004 | −0.002 | −0.015 | 0.500 | 0.500 |
| 5.0 | 0.600 | 1.542 | −0.018 | −0.007 | −0.067 | 0.497 | 0.500 |
| 7.5 | 1.179 | 2.739 | −0.041 | −0.016 | −0.145 | 0.489 | 0.499 |
| 10.0 | 2.018 | 4.398 | −0.070 | −0.028 | −0.251 | 0.468 | 0.496 |
| 12.5 | 3.132 | 6.565 | −0.112 | −0.045 | −0.402 | 0.426 | 0.489 |
| 15.0 | 4.544 | 9.295 | −0.157 | −0.064 | −0.562 | 0.359 | 0.476 |

List Five

f = 2.525 Fno = 16.872 BL = 2.171

| angle | spotsize | spotsize | Field | Field | Dis- | MTF | MTF |
|---|---|---|---|---|---|---|---|
| (deg.) | RMS | GEO | TAN | SAG | tortion | (TAN) | (SAG) |
| 0.0 | 0.217 | 0.426 | 0.000 | 0.000 | 0.000 | 0.292 | 0.292 |
| 2.5 | 0.280 | 0.725 | −0.006 | −0.003 | −0.010 | 0.292 | 0.292 |
| 5.0 | 0.593 | 1.486 | −0.029 | −0.011 | −0.046 | 0.292 | 0.293 |
| 7.5 | 1.194 | 2.638 | −0.063 | −0.025 | −0.100 | 0.289 | 0.293 |
| 10.0 | 2.072 | 4.301 | −0.109 | −0.043 | −0.173 | 0.283 | 0.292 |
| 12.5 | 3.239 | 6.488 | −0.173 | −0.070 | −0.277 | 0.269 | 0.291 |
| 15.0 | 4.718 | 9.255 | −0.243 | −0.098 | −0.387 | 0.246 | 0.288 |

### The Second Embodiment

Refer to FIG. 9, a double-layer liquid crystal lens with variable focus 2 of the present invention comprising: in the order from an object side to an image side, a single-side electrode glass substrate 10b, a spacer 40, a first liquid crystal layer 30, a double-side electrode glass substrate 10a, a spacer 40, a second liquid crystal layer 30 and a single-side electrode glass substrate 10b. Wherein, the spacers 40 are arranged among the two single-side electrode glass substrates 10b and the double-side electrode glass substrate 10a to define the two liquid crystal layers 30. The incident light passes the first liquid crystal layer 30 and the second liquid crystal layer 30, being reflected twice. Wherein, the metal membrane of the surface electrode pattern 20 is made from silver in this embodiment. When voltage is applied to the first liquid crystal layer 30 as well as the second liquid crystal layer 30 respectively and the reflective index n₁ and n₂ are generated, the focus position of the light is calculated by the equation (2). While the device being applied to cameras, or phone cameras, varifocal now is available by control of the voltage of the first as well as the second liquid crystal layers. Compare with conventional multiple-piece lens module, the space is saved dramatically.

The material of the liquid crystal layer 30, the thickness of the spacer 40, the material as well as the thickness of the glass substrate 10 and the surface electrode pattern 20 in this embodiment are the same with those in the first embodiment. When the total focal length of this embodiment is 0.866 mm, the first liquid crystal layer 30 is applied with 2.15V voltage so as to have the focal length of 1.111 mm while the second liquid crystal layer 30 is applied with 1.49V so as to have the focal length of 2.525 mm. The list six shows related optical parameters in various angles (degrees) when the focal length of this embodiment is 0.866 mm.

List Six

f = 0.866 Fno = 5.774 BL = 0.202

| angle | spotsize | spotsize | Field | Field | Dis- | MTF | MTF |
|---|---|---|---|---|---|---|---|
| (deg.) | RMS | GEO | TAN | SAG | tortion | (TAN) | (SAG) |
| 0.0 | 0.151 | 0.348 | 0.000 | 0.000 | 0.000 | 0.743 | 0.743 |
| 2.5 | 0.225 | 0.528 | −0.001 | 0.000 | −0.058 | 0.743 | 0.743 |
| 5.0 | 0.413 | 0.962 | −0.004 | −0.002 | −0.263 | 0.740 | 0.743 |
| 7.5 | 0.700 | 1.670 | −0.009 | −0.005 | −0.568 | 0.733 | 0.741 |
| 10.0 | 1.095 | 2.606 | −0.016 | −0.008 | −0.990 | 0.718 | 0.738 |
| 12.5 | 1.602 | 3.747 | −0.026 | −0.013 | −1.604 | 0.690 | 0.732 |
| 15.0 | 2.229 | 5.106 | −0.036 | −0.018 | −2.271 | 0.644 | 0.721 |

When the total focal length of this embodiment is changed into 0.746 mm, the first liquid crystal layer 30 is applied with 1.74V voltage so as to have the focal length of 1.720 mm while the second liquid crystal layer 30 is applied with 2.31V so as to have the focal length of 1.013 mm. The list seven shows related optical parameters in various angles (degrees) when the focal length of this embodiment is 0.746 mm.

List Seven

f = 0.746 Fno = 4.974 BL = 0.214

| angle | spotsize | spotsize | Field | Field | Dis- | MTF | MTF |
|---|---|---|---|---|---|---|---|
| (deg.) | RMS | GEO | TAN | SAG | tortion | (TAN) | (SAG) |
| 0.0 | 0.279 | 0.482 | 0.003 | 0.003 | 0.000 | 0.778 | 0.778 |
| 2.5 | 0.315 | 0.599 | 0.003 | 0.003 | −0.074 | 0.777 | 0.778 |
| 5.0 | 0.417 | 0.801 | 0.001 | 0.002 | −0.332 | 0.773 | 0.778 |
| 7.5 | 0.578 | 1.098 | −0.001 | 0.001 | −0.720 | 0.766 | 0.778 |
| 10.0 | 0.795 | 1.483 | −0.004 | −0.001 | −1.255 | 0.755 | 0.777 |
| 12.5 | 1.069 | 2.139 | −0.008 | −0.004 | −2.032 | 0.739 | 0.774 |
| 15.0 | 1.396 | 2.936 | −0.013 | −0.007 | −2.880 | 0.709 | 0.775 |

### The Third Embodiment

Refer to FIG. 10, a multiple-layer liquid crystal lens with variable focus 3 of the present invention, in FIG. 10 is shown a triple-layer liquid crystal lens, comprising of a single-side electrode glass substrate 10b, a spacer 40, a first liquid crystal layer 30, a double-side electrode glass substrate 10a, a spacer 40, a second liquid crystal layer 30, a double-side electrode glass substrate 10a, a spacer 40, a third liquid crystal layer 30, and a single-side electrode glass substrate 10b from the object side to the image side. The spacers 40 are arranged among the two single-side electrode glass substrates 10b on outer side and the two double-side electrode glass substrates 10a on inner side to define the three liquid crystal layers 30. The incident light passes the first liquid crystal layer 30, the second liquid crystal layer 30, and the third liquid crystal layer 30, being reflected three times. When voltage is applied to the first liquid crystal layer 30, the second liquid crystal layer 30 and the third liquid crystal layer 30 respectively so as to make the first, the second and the third liquid crystal layers 30 respectively have the reflective index n₁, n₂ and n₃. The focus position of the light is calculated by the equation (2). Thus varifocal now is available.

In summary, the present invention has the following advantages:

(1) The change of the focus is made by liquid crystal lens unit and there is no need to arrange mechanical driving part so that the whole module is more compact and light weighted.

(2) Instead of conventional ITO electrode, the surface electrode pattern 20 of the present invention is made from an aluminum membrane (or other transparent metal membranes such as silver membrane) so that the cost is reduced.

(3) The surface electrode pattern 20 of the present invention can be designed into various patterns such as a single hole pattern, or a concentric circle pattern. Moreover, by different electronic field types generated by the surface electrode pattern 20, various aperture sizes are generated. Then in combination with single layer or multiple layer liquid crystal lens unit, a practical lens with variable focus is formed and is applied to cameras, phone cameras, or image processing devices.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A liquid crystal lens with variable focus comprising a single-layer liquid crystal lens unit; wherein the single-layer liquid crystal lens unit includes two glass substrates with preset thickness disposed with single-side electrode or double-side electrode and then the two electrode glass substrates are arranged in parallel with preset distance by a spacer so as to form a space with preset thickness there between for accommodation of crystal liquid molecules to form a liquid crystal layer; the characteristic is in:
at least one surface electrode pattern disposed on the single-side electrode glass substrate or double-side electrode glass substrate is formed by coating a transparent metal membrane on surface of the glass substrate and then the metal membrane is etched to form preset pattern while the electrode on each electrode glass substrate is controlled independently by being applied with voltage respectively;
wherein when the surface electrode pattern on surface of the two electrode glass substrates are applied with specific voltage, arrangement of the liquid crystal molecules of the liquid crystal layer is tuned to generate specific refractive index.

2. A liquid crystal lens with variable focus comprising a double-layer liquid crystal lens unit; wherein the double-layer liquid crystal lens unit includes three glass substrates with preset thickness disposed with single-side electrode or double-side electrode and then the three electrode glass substrates are arranged in parallel with preset distance by spacers so as to form a space with preset thickness between the two contiguous electrode glass substrates for accommodation of crystal liquid molecules to form two liquid crystal layers; the characteristic is in:
at least one surface electrode pattern disposed on the single-side electrode glass substrate or double-side electrode glass substrate is formed by coating a transparent metal membrane on surface of the glass substrate and then the metal membrane is etched to form preset pattern while the electrode on each electrode glass substrate is controlled independently by being applied with voltage respectively;
wherein when the surface electrode pattern on surface of the two adjacent electrode glass substrates are applied with specific voltage, arrangement of the liquid crystal molecules of each liquid crystal layer is tuned to generate specific refractive index.

3. A liquid crystal lens with variable focus comprising a multiple-layer liquid crystal lens unit;
wherein the multiple-layer liquid crystal lens unit includes at least four glass substrates with preset thickness disposed with single-side electrode or double-side electrode and then the at least four electrode glass substrates are arranged in parallel with preset distance by spacers so as to form a space with preset thickness between the two contiguous electrode glass substrates for accommodation of crystal liquid molecules to form at least three liquid crystal layers;
the characteristic is in:
at least one surface electrode pattern disposed on the single-side electrode glass substrate or double-side electrode glass substrate is formed by coating a transparent metal membrane on surface of the glass substrate and then the metal membrane is etched to form preset pattern while the electrode on each electrode glass substrate is controlled independently by being applied with voltage respectively;
wherein when the surface electrode pattern on surface of the two adjacent electrode glass substrates are applied with specific voltage, arrangement of the liquid crystal molecules of each liquid crystal layer of the liquid crystal lens unit is tuned to generate specific refractive index.

4. The device as claimed in claim 1, wherein the transparent metal membrane coated on surface of the glass substrate is made from aluminum or silver.

5. The device as claimed in claim 2, wherein the transparent metal membrane coated on surface of the glass substrate is made from aluminum or silver.

6. The device as claimed in claim 3, wherein the transparent metal membrane coated on surface of the glass substrate is made from aluminum or silver.

7. The device as claimed in claim 1, wherein the preset pattern of the surface electrode pattern is a single hole pattern or a concentric circle pattern.

8. The device as claimed in claim 2, wherein the preset pattern of the surface electrode pattern is a single hole pattern or a concentric circle pattern.

9. The device as claimed in claim 3, wherein the preset pattern of the surface electrode pattern is a single hole pattern or a concentric circle pattern.
